(19) United States
(12) Patent Application Publication
(10) Pub. No.: US 2010/0045733 A1
(43) Pub. Date: Feb. 25, 2010

(54) FLUID EJECTING APPARATUS

(75) Inventor: Takashi Mano, Shiojiri-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/543,643

(22) Filed: Aug. 19, 2009

(30) Foreign Application Priority Data
Aug. 20, 2008 (JP) 2008-211598

(51) Int. Cl. B41J 2/165

(52) U.S. Cl. 347/29

(57) ABSTRACT

A fluid ejecting apparatus includes a fluid ejecting head with a nozzle forming face having formed thereon a plurality of nozzles for ejecting fluid, a cap that is able to form a sealed space together with the nozzle forming face by being in contact with the nozzle forming face, a decompressing unit that is coupled to the cap so as to decompress the sealed space via a first channel, an ambient air ventilating unit that is coupled to the cap so as to open the sealed space to ambient air via a second channel, and a check valve that is provided on the second channel between the cap and the ambient air ventilating unit.

### BACKGROUND

1. Technical Field

present invention relates to a fluid ejecting apparatus.

2. Related Art

An ink jet printer, for example, is well known as a fluid ejecting apparatus that ejects a fluid. Such an ink jet printer records characters or images on a recording medium and is configured such that ink (fluid) is selectively ejected from a row of nozzles provided on a recording head (a fluid ejecting head).

In such an ink jet printer, in order to prevent a malfunction in ejection of ink due to clogging in a nozzle, entering of dust, increase in viscosity of the ink or generation of bubbles in the ink, a suction operation is performed such that a nozzle forming face of a recording head is sealed by a cap, a sealed space formed between the cap and the nozzle forming face is decompressed by means of a suction pump, thereby sucking ink having increased viscosity through the nozzle to eject it into the cap. An ambient air ventilating valve is connected to the cap through an ambient air communication tube. After the suction operation is finished, ink is supplied from the head to release the negative pressure. After that, the ambient air ventilating valve is opened, and an operation for sucking out the ink residing in the cap and adhering to the nozzle face is performed. JP-A-2005-225163 is an example of the related art that discloses a cap having an ambient air ventilating valve.

A discharge tube coupling the suction pump to the cap is filled with ink by the suction operation. As a result, when the sucking pump is stopped, ink flows into the ambient air communication tube which is a space with a negative pressure. Therefore, the ambient air ventilating valve connected to the ambient air communication tube is positioned to be vertically higher than the cap so that when the valve is opened, the ink does not leak to the outside due to the hydraulic head difference.

However, in order to realize the above structure, the length of the ambient air communication tube has to be increased so that an amount of ink flowing therein from the cap is increased. As a result, a large amount of the ink is returned to the cap together with air when opened to the ambient air, which causes a problem that the ink returned to the cap may adhere to the nozzle forming face or may bubble.

In order to reduce the amount of ink flowing into the ambient air communication tube from the cap, the ambient air ventilating valve can be provided at a portion of the ambient air communication tube at the upper end side, i.e., in the vicinity of the cap. However, ink may possibly leak to the outside when the valve is opened.

### SUMMARY

An advantage of some aspects of the invention is that it provides a fluid ejecting apparatus capable of improving a processing effect and an operating efficiency of a cleaning operation including a suction operation.

A fluid ejecting apparatus according to a first aspect of the invention includes a fluid ejecting head with a nozzle forming face having formed thereon a plurality of nozzle for ejecting fluid, a cap that is able to form a sealed space together with the nozzle forming face by being in contact with the nozzle forming face, a decompressing unit that is coupled to the cap so as to decompress the sealed space via a first channel, an ambient air ventilating unit that is coupled to the cap so as to open the sealed space to ambient air via a second channel, and a check valve that is provided on the second channel between the cap and the ambient air ventilating unit.

In the invention, the check valve is provided between the cap and the ambient air ventilating unit. The check valve is adapted to cause air to be supplied to the inside of the cap from the outside and to block the reverse flow of air and fluid. As a result, even when the ambient air ventilating unit is provided below the cap, it is possible to prevent the fluid from flowing to the outside when the ambient air ventilating unit is opened. Therefore, it is possible to maintain a good condition that is obtained by a cleaning operation including a suction operation by means of the decompressing unit and to achieve the fluid ejecting apparatus capable of improving the operational efficiency in the cleaning operation.

In addition, it is preferable to dispose the check valve at a portion in the vicinity of the cap. With this configuration, since the check valve is disposed in the vicinity of the cap, it is possible to reduce a decompressed space between the cap and the check valve, thereby reducing an amount of fluid that reversely flows from the cap to the check valve. As a result, in a case where the ambient air ventilating unit is opened, an amount of fluid that is returned to the cap in conjunction with the supplying of air is reduced, thereby suppressing fluctuation (bubbling) of the fluid in the cap.

Further, in addition, it is preferable that the check valve functions as an ambient air inflow rate control unit that controls an inflow rate of ambient air flowing in the cap while the ambient air ventilating unit is in an open operation state. With this configuration, since the check valve functions as the ambient air inflow rate control unit that controls the inflow rate of the ambient air flowing in the cap in the open operation state, it is possible to prevent a pressure in the sealed space from being rapidly increased even when the ambient air ventilating unit is opened. For example, in a case where an opening level of the check valve is set to be a predetermined one and an amount of air to be introduced in a unit of time is determined, it is possible to open the ambient air ventilating unit just after the cleaning operation is finished. Namely, only a predetermined amount of air is introduced in the cap per a unit of time so that it is possible to prevent a pressure in the cap from being rapidly increased. As a result, it is possible to suppress fluctuation of the fluid in the cap, thereby eliminating a malfunction due to bubbling of ink.

### BRIEF DESCRIPTION OF THE DRAWINGS

The invention will be described with reference to the accompanying drawings, wherein like numbers reference like elements.

FIG. 1 is a schematic perspective view showing an entire structure of a printer an embodiment according to the invention.

FIG. 2 is a cross sectional view showing a schematic structure of a maintenance mechanism.

### DESCRIPTION OF EXEMPLARY EMBODIMENTS

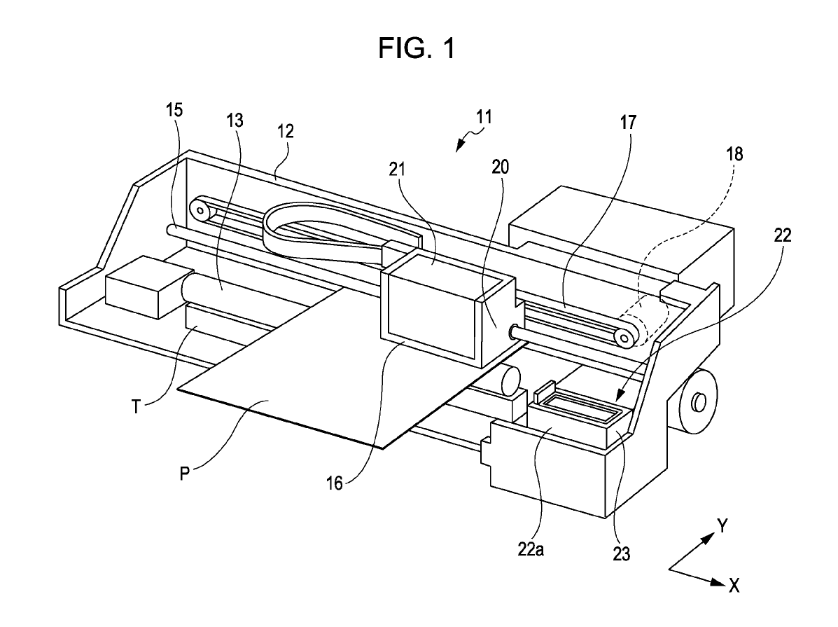

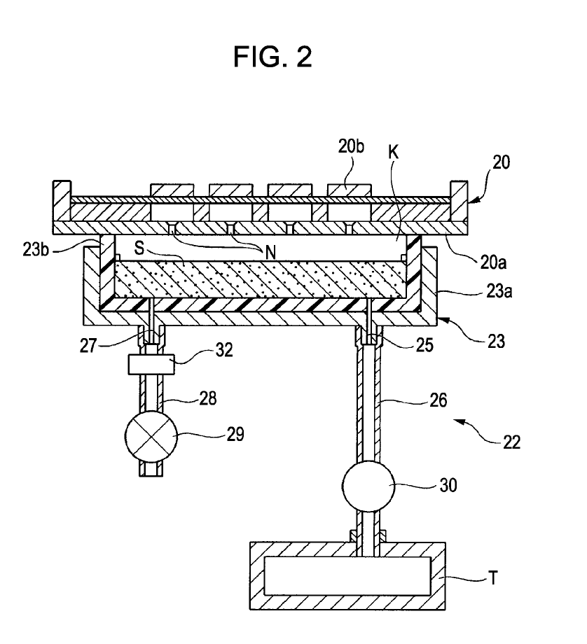

An embodiment of a fluid ejecting apparatus is described below with reference to FIGS. 1 and 2. FIG. 1 is a schematic perspective view showing a main part of an ink jet printer 11 as the fluid ejecting apparatus. FIG. 2 is a schematic view showing a main part of a maintenance mechanism 22.

As shown in FIG. 1, the ink jet printer 11 has a frame 12 to which a platen 13 is attached. A recording paper sheet P as a target is fed on the platen 13 by a paper transporting mechanism (not shown). A guide member 15 is attached to the frame 12 in parallel to the longitudinal direction of the platen 13 and a carriage 16 is slidably supported on the guide member 15. The carriage 16 can be reciprocated in a direction (a direction X in FIG. 1) orthogonal to the transporting direction of the recording paper sheet P by a carriage motor 18 via a timing belt 17.

A recording head 20 is provided on the lower face of the carriage 16. The recording head 20 is equipped with a plurality of nozzles N open in its lower face as shown in FIG. 2. The nozzles N are arranged such that a nozzle forming face 20a faces the fed recording paper sheet P. By driving a piezoelectric element 20b, an ink droplet is ejected toward the recording paper sheet P from the nozzle N.

An ink cartridge 21 containing ink therein is detachably attached to the carriage 16. The ink cartridge 21 provided in the carriage 16 is adapted to supply ink to the recording head 20 provided below the ink cartridge 21. The driving of the piezoelectric element 20b in accordance with print data causes the supplied ink to be ejected to the recording paper sheet P via the nozzles N.

A home position is located at a side part of the frame 12 and the maintenance mechanism 22 is provided at the home position. The home position is an area where the carriage 16 is placed when the printer is in a non-printing state, such as when printing is not being performed or when the carriage 16 is being stored. The maintenance mechanism 22 is equipped with the cap 23 and a suction pump 30 (see FIG. 2) constituting a decompressing unit, the cap 23 and the suction pump 30 being provided in a case 22a. The maintenance mechanism 22 is further equipped with a driving motor (not shown) as a driving source for the cap 23 and the suction pump 30, and a driving source transmission mechanism (not shown) for transmitting a driving force of the driving motor to the cap 23 and the suction pump 30.

As shown in FIG. 2, the cap 23 has a cap holder 23a and a cap member 23b. The cap holder 23a is formed to be in a shape of a box having an open upper side and is disposed such that an open face of the cap holder 23a faces the nozzle forming face 20a of the recording head 20. The cap member 23b is made of an elastic material such as an elastomer and is supported by an inner face of the cap holder 23a. The upper edge of the cap member 23b protrudes upward to a level higher than the upper edge of the cap holder 23a.

The cap holder 23a is attached to the inner section of the case 22a so as to be vertically movable by the driving force of the driving motor. The cap 23 is reciprocally movable between a capping position where the cap member 23b is brought into contact with the recording head 20 and a retracting position where the cap member 23b is separated from the recording head 20.

A sheet-like ink absorption material S made of sponge is provided to the bottom face of the cap member 23b. The ink absorption material S is adapted to receive and absorb ink ejected from the recording head 20. When the cap 23 seals the nozzle forming face 20a, a solvent of the absorbed ink is evaporated in a space (hereinafter referred to as a sealed space K) formed by the nozzle forming face 20a and the cap 23, thereby preventing the nozzles N from being dried.

An ink discharge hole 25 is formed at the bottom face of the cap holder 23a so as to pass therethrough and a discharge tube 26 (a first channel) is connected to the lower face of the cap holder 23a. The ink discharge hole 25 and a fluid channel in the discharge tube 26 are coupled to each other. Ink that has been ejected into the cap 23 flows into the fluid channel in the discharge tube 26 through the ink discharge hole 25. While the discharge tube 26 is shown as being straight in FIG. 2 for convenience, the discharge tube 26 is generally accommodated in the case 22a such that it is below the cap 23 and extends toward the suction pump 30.

The suction pump 30 is disposed above the discharge tube 26. The suction pump 30 is adapted to perform a head cleaning operation for sucking out ink remaining in the nozzles N. The head cleaning operation is performed when a controller (not shown) of the printer issues an execution command in a case where the printer stops printing for a long time and restarts printing. At that time, the carriage 16 is moved to the home position so as to place the recording head 20 above the cap 23.

An air ventilation hole 27 is formed at the bottom face of the cap 23 so as to pass therethrough, and an air ventilation tube 28 (second channel) is coupled to the air ventilation hole 27. An ambient air ventilating valve 29 (an ambient air ventilating unit) is provided at the end of the air ventilation tube 28. When the ambient air ventilating valve 29 is made to be in an open state, the sealed space K residing between the nozzle forming face 20a and the cap 23 is connected to the ambient air via the air ventilation hole 27.

In the embodiment, a check valve 32 (an ambient air inflow rate control unit) is provided between the cap 23 disposed above the air ventilation tube 28 and the ambient air ventilating valve 29. As shown in FIG. 2, the check valve 32 is provided in the vicinity of the cap 23 at the upper end side of the air ventilation tube 28. The check valve 32 enables supplying of air only in an advancing direction toward the cap 23 from the outside, but is automatically closed when air or ink tries to flow from the cap 23. Namely, when a pressure at the upper end side of the check valve 32 (a pressure in the sealed space K) is lower than a pressure at the lower end side (the ambient air pressure), air is supplied from the outside. After the pressure at the upper end side is roughly balanced with the pressure at the lower end side, reverse flow of air to the ambient air ventilating valve 29 side is blocked and ink is prevented from flowing out.

The check valve 32 in the embodiment is opened when the air ventilation tube 28 at the cap 23 side has a predetermined negative pressure. A valve opening amount of the check valve 32 is set to a predetermined amount. To be specific, the amount of air to be supplied per unit time is such that ink in the cap 23 does not bubble and is preferably greater than the amount of ink that is unconditionally introduced from the recording head 20 to the decompressed space (the sealed space K). As a result, by increasing the amount of the supplied air so as to be in a range that the ink in the cap 23 does not bubble, it is possible to open the sealed space K earlier than in the past. The valve opening amount of the check valve 32 can be controlled by an amount of a stroke (a spring force) of, for example, a spool (not shown) or an air ventilation hole provided on the spool. Alternatively, it is possible to control the opening amount of the check valve 32 by a controller for convenience.

On the other hand, the check valve 32 is opened when the pressure in the air ventilation tube 28 at the cap 23 side becomes or approaches the ambient air pressure. Here, it is preferable that a valve closing pressure of the check valve 32 is set under a condition that a pressure difference whereby the check valve 32 is opened when the pressure in the air ventilation tube 28 at the upper end side at a position higher than the check valve 32 approaches the ambient air pressure is, grasped beforehand.

Next, an embodiment of an operation of the printer is explained by mainly describing the head cleaning operation. When an execution command for the head cleaning operation is issued, the cap holder 23a is moved upward by the driving motor and the driving force transmission mechanism to be placed in a capping position so that the cap member 23b is brought into contact with the nozzle forming face 20a. When the cap is placed in the capping position, the ambient air ventilating valve 29 is opened. For this reason, the space in the cap 23 is sealed under the condition that it communicates with the discharge tube 26 and the air ventilation tube 28.

The suction pump 30 is driven under the condition that the nozzle forming face 20a is sealed by the cap 23. As a result, the air in the discharge tube 26 and in the sealed space K of the cap 23 is discharged by the suction pump 30, and the ink in the nozzles N is sucked by virtue of the generated negative pressure. The ink ejected from the nozzles N is absorbed by the ink absorption material S to be allowed to flow into the discharge tube 26. After that, the ink is stored in a waste ink tank T provided below the suction pump 30 in the frame 12.

As described above, since the ambient air ventilating valve 29 is closed, when the inner section of the air ventilation tube 28 between the cap 23 and the check valve 32 is made to have negative pressure by driving the suction pump 30, the check valve 32 is temporarily opened by virtue of the pressure difference with respect to the pressure (the ambient air pressure) in the air ventilation tube 28 between the check valve 32 and the ambient air ventilating valve 29. After that, the inner section of the air ventilation tube 28 between the check valve 32 and the ambient air ventilating valve 29 immediately has negative pressure and the check valve 32 is closed.

After the cleaning operation is completed, the suction pump 30 is stopped. As a result, the ink in the cap 23 flows into the air ventilation tube 28 that has negative pressure. Since the check valve 32 is closed at that time, the ink is not allowed to flow out any more.

After that, the ambient air ventilating valve 29 is opened. The opening of the ambient air ventilating valve 29 causes the check valve 32 to be opened and the air is introduced into the cap 23. The ink is returned to the cap 23 in conjunction with the introduction of the air. Since the check valve 32 is set to be open by predetermined valve opening amount, the pressure in the cap 23 can be immediately increased without bubbling the ink. When the negative pressure in the sealed space K is released so that the pressure in the sealed space K becomes roughly equal to the ambient air pressure, the check valve is closed. Thus, the sealed space K in the cap 23 having the accumulated negative pressure is allowed to communicate with the ambient air so that the cap member 23b becomes separated from the recording head 20.

In the embodiment, the check valve 32 is provided above the air ventilation tube 28 disposed between the cap 23 and the ambient air ventilating valve 29. The check valve 32 allows only air to flow into the cap 23 from the air ventilation tube 28 at the lower end side, but blocks reverse flow of the air and prevents the ink from flowing out of the cap 23 side. For example, under a condition that the valve opening amount of the check valve 32 is set at a predetermined level and an amount of air to be introduced per unit time is determined, even when the ambient air ventilating valve 29 is opened immediately after the cleaning operation (the suction operation) is completed, air in the predetermined amount is introduced into the cap 23 per unit time so that it is possible to prevent the pressure in the cap 23 from being suddenly increased. As a result, it is possible to prevent the ink in the cap 23 from being moved (bubbled), thereby maintaining a good condition of the recording head after performing the cleaning operation.

In addition, it is not necessary to manage an open period (a leaving time period) of the ambient air ventilating valve 29 and it is possible to open the ambient air ventilating valve 29 after finishing the cleaning operation. Namely, it is possible to reduce a time period from when the suction pump 30 is stopped until the sealed space K is open in the ambient air so that the sealed space K can reach the ambient air pressure earlier than in the past. As a result, the operating efficiency in the cleaning is improved and the process in the printer can smoothly progress to the printing operation.

The check valve 32 is disposed on a portion at the upper side of the air ventilation tube 28 in the vicinity of the cap 23. Therefore, it is possible to suppress the amount of the ink that flows into the air ventilation tube 28 after the cleaning operation is finished and the suction pump 30 is stopped. Consequently, it is possible to reduce the amount of ink that flows into the cap 23 together with air when the ambient air ventilating valve 29 is open.

In the above, while the preferred embodiments according to the invention are described with reference to FIGS. 1 and 2, it is needless to say that the invention is not limited to the foregoing embodiments, and the above embodiments can be combined. It will be apparent to those skilled in the art that various modifications and variations can be made in the invention within the spirit and scope of the appended claims so that it will be understood that these are obviously within the technical scope of the invention.

In the embodiment, while the ink jet type printer and the ink cartridge are used, a fluid ejecting apparatus capable of ejecting a fluid other than the ink and a fluid container containing the fluid can be used.

This invention can be applied to various types of fluid ejecting apparatuses each including a fluid ejecting head for ejecting a liquid droplet constituted by a small amount of liquid. A liquid droplet refers to a state of a fluid ejected from the fluid ejecting apparatus and includes a particle-like droplet, a teardrop-like droplet and a string-like droplet having a tail. The fluid in the above description may be a material that can be ejected from the fluid ejecting apparatus. For example, a material that is in a liquid phase can be used. The materials include a material in a liquid state having a high or low viscosity, a material in a fluid state such as sol, gel water, an inorganic solvent other than these, an organic solvent, a solution, a liquid resin, and a liquid metal (a metal melt). The material is not only a substance in a fluid state, but also can be one formed such that particles of a functional material made of a solid such as a pigment or a metal are dissolved, dispersed or mixed with a solvent.

As a representative example of the fluid, ink as described in the embodiment or a liquid crystal can be given. Here, the ink can be one of various fluid compositions such as generic aqueous ink, oil-based ink, gel ink and hot melt ink.

A specific example of the fluid ejecting apparatus according to the invention can be a fluid ejecting apparatus that ejects a fluid including a material such as an electrode material or a colorant dispersed or dissolved therein, the electrode material or the colorant being used for manufacturing, for example, a liquid crystal display, an EL (electroluminescence) display, a surface light emitting display or a color filter. The invention can be applied to a fluid ejecting apparatus that ejects a living organic material to be used for manufacturing a biochip, a fluid ejecting apparatus used as a precise pipette that ejects a fluid to be a specimen, a cloth printing apparatus or a micro dispenser.

This invention can be applied to a fluid ejecting apparatus that ejects grease to a precision machine such as a watch or a camera in a pinpoint manner, a fluid ejecting apparatus that ejects transparent resin liquid of an ultraviolet curable resin in order to form a fine hemispherical lens (an optical lens) to be used for an optical communication element or a fluid ejecting apparatus that ejects acid or alkaline etching liquid for etching a substrate. It is possible to apply the invention to either one of the ejecting apparatuses and a fluid container.

The entire disclosure of Japanese Patent Application No. 2008-211598, filed Aug. 20, 2008 is expressly incorporated by reference herein.

What is claimed is:

1. A fluid ejecting apparatus comprising:
a fluid ejecting head with a nozzle forming face having formed thereon a plurality of nozzles for ejecting fluid;
a cap that is able to form a sealed space together with the nozzle forming face by being in contact with the nozzle forming face;
a decompressing unit that is coupled to the cap so as to decompress the sealed space via a first channel;
an ambient air ventilating unit that is coupled to the cap so as to open the sealed space to ambient air via a second channel; and
a check valve that is provided on the second channel between the cap and the ambient air ventilating unit.

2. The fluid ejecting apparatus according to claim 1, wherein,
the check valve is disposed in the vicinity of the cap.

3. The fluid ejecting apparatus according to claim 1, wherein,
the check valve functions as an ambient air inflow rate control unit that controls an inflow rate of ambient air flowing into the cap while the ambient air ventilating unit is in an open operation state.
